(19) United States
(12) Patent Application Publication
(10) Pub. No.: US 2025/0320957 A1
(43) Pub. Date: Oct. 16, 2025

(54) MOVABLE STAND FOR UMBRELLA AND RELATED METHODS

(71) Applicant: ATLeisure, LLC, Atlanta, GA (US)

(72) Inventor: William M. Browne, Atlanta, GA (US)

(21) Appl. No.: 19/178,547

(22) Filed: Apr. 14, 2025

Related U.S. Application Data
(60) Provisional application No. 63/634,191, filed on Apr. 15, 2024.

(51) Int. Cl. F16M 11/42; B60B 33/06; E04H 12/22

(52) U.S. Cl. CPC F16M 11/42; B60B 33/066; E04H 12/2246

(57) ABSTRACT

A stand is for moving an umbrella on a surface. The stand includes a base assembly to receive the umbrella and being over the surface, and arms. Each arm has a proximal end coupled to the base assembly, and a distal end extending outwardly from the base assembly. The stand also includes wheels respectively coupled to the distal ends of the arms, and supports coupled to the base assembly and extending outwardly from the base assembly, each of the supports has a pivot point for a respective one of the arms. The stand includes an actuator assembly coupled to the base assembly and configured to cause the base assembly to switch between a first stationary state and a second movable state.

### RELATED APPLICATION

This application is based upon prior filed Application No. 63/634,191 filed Apr. 15, 2025, the entire subject matter of which is incorporated herein by reference in its entirety.

### TECHNICAL FIELD

The present disclosure relates to the field of outdoor accessories, and, more particularly, to a stand for an umbrella and related methods.

### BACKGROUND

Large patio-style umbrellas are useful on patios, decks, pools, beaches, and in other outdoor settings for providing protection from the sun and allowing users a convenient way to enjoy shade while participating in outdoor activities. Typically, the umbrella comprises a mast extending from a base, and a canopy coupled to the mast opposite to the base. A drawback to this design is that the mast and base occupy some of the shaded area, thereby limiting the usable area.

In some approaches, as disclosed in, for example, U.S. Pat. No. 5,937,882 to Harbaugh, assigned to the present application's assignee, the umbrella uses an offset/cantilever arrangement. In this example, the main pole utilizes a cantilever arrangement to suspend the canopy to the side of the main pole so that the main pole does not occupy space in the shaded area beneath the canopy. For additional convenience, the angle of the canopy can be adjusted with respect to the main pole. A potential drawback to this design is the utilization of a crank mechanism both for raising and lowering the canopy and for adjusting the angle of the canopy. Typically, the crank mechanism is mounted to the main pole, and the rope moves along a complex path with many turning points. This arrangement may require more winding force, and the rope may bind and wear, adversely affecting the umbrella's operation.

In another approach disclosed in U.S. Pat. No. 8,104,492 to Dan, also assigned to the present application's assignee, the umbrella includes separate mechanisms for opening and closing the canopy and adjusting the angle of the canopy. Here, the sliding collar adjusts the angle of the canopy, and the winch on the sliding collar controls the opening and closing of the canopy.

With patio-style umbrellas, due to the large area of the umbrella surface when the large umbrella is opened, it is usually fixed onto an umbrella stand to ensure the stability and balance of the umbrella. In order to prevent the umbrella from tipping over due to wind, current umbrellas need to be equipped with umbrella stands with sufficient weight. To maintain balance with the umbrella canopy, umbrella stands are generally large in volume or heavy in weight. When the umbrella stand has sufficient weight and a large landing area, it is very inconvenient to move the umbrella stand. To solve the above technical problems, some umbrella stands are equipped with wheels, making it more convenient to move the umbrella stand. When the wheels are not needed, they are hidden at the bottom of the umbrella stand. When the umbrella stand touches the ground, the wheels are hidden; when the wheels are needed, they are manually operated to roll freely when in contact with the ground. However, hiding and deploying the wheels requires manual operation, which is very labor-intensive.

In one approach, for example, as disclosed in Chinese Patent Document No. CN215259008U, an electrically operated lifting and movable umbrella stand includes a base, an airbag, a wheel frame, and casters arranged from top to bottom. The wheel frame is installed at the bottom of the base through connecting pieces. The casters are installed on the wheel frame, and the airbag is installed between the wheel frame and the base. The airbag is connected to the inflation device installed on the base through an air pipe. When the airbag is inflated and in an expanded state, the lower end of the casters protrudes from the bottom of the base. When the airbag is deflated and in a contracted state, the bottom of the base is below the casters. However, this umbrella stand requires the user to inflate and deflate the airbag inside it, which is not flexible and convenient to use.

In one approach disclosed in Chinese Patent Document No. CN212719002U, this base includes a base component, a screw rotating in cooperation with the center of the base component, a rocking hand lever driving the screw to rotate, multiple rods rotating in cooperation with the base component, and multiple bottom wheels corresponding to the rods. The lower end of the screw is threaded with a lifting block, which is connected to the rod in cooperation with the lifting block. However, this structure requires manual rotation, and the user needs to bend over to operate it, making it relatively inconvenient to use. Additionally, existing mobile umbrella stands, due to their size, are usually transported separately from the umbrellas, which need to be purchased separately, resulting in relatively high overall logistics costs.

### SUMMARY

Generally, a stand is for moving an umbrella on a surface. The stand includes a base assembly to receive the umbrella and being over the surface, and a plurality of arms, each arm having a proximal end coupled to the base assembly, and a distal end extending outwardly from the base assembly. The stand also includes a plurality of wheels respectively coupled to the distal ends of the plurality of arms, and a plurality of supports coupled to the base assembly and extending outwardly from the base assembly, each of the plurality of supports comprises a pivot point for a respective one of the plurality of arms. The stand comprises an actuator assembly coupled to the base assembly and configured to cause the base assembly to switch between a first stationary state and a second movable state. The first stationary state comprises the distal ends of plurality of arms with the plurality of the wheels extending upward and away from the surface and the base assembly adjacent to the surface, and the second moving state comprises the distal ends of plurality of arms with the plurality of the wheels abutting the surface and the base assembly being spaced apart from the surface.

In particular, the base assembly may comprise an upper platform to receive the umbrella, a lower platform coupled to the upper platform, and a lift joint between the upper platform and the lower platform and coupled to the proximal ends of the plurality of arms. The base assembly may also comprise a plurality of legs coupled between the upper platform and the lower platform.

In some embodiments, the actuator assembly may comprise a housing, a lever having a first end coupled to the base assembly and a second end, and an actuator device coupled to the second end of the lever. The actuator device may comprise a foot pedal. For example, the actuator device may comprise a pneumatic device.

Also, the stand may also comprise a plurality of peripheral supports respectively coupled between the plurality of supports. The stand may comprise an anchor weight over the base assembly and the plurality of arms. Each arm may pivot on a respective support when switching between the first stationary state and

Another aspect is directed to an umbrella assembly. The umbrella assembly includes an umbrella, and a stand for moving the umbrella on a surface. The stand includes a base assembly to receive the umbrella and being over the surface, and a plurality of arms. Each arm has a proximal end coupled to the base assembly, and a distal end extending outwardly from the base assembly. The stand also includes a plurality of wheels respectively coupled to the distal ends of the plurality of arms, and a plurality of supports coupled to the base assembly and extending outwardly from the base assembly. Each of the plurality of supports comprises a pivot point for a respective one of the plurality of arms. The stand comprises an actuator assembly coupled to the base assembly and configured to cause the base assembly to switch between a first stationary state and a second movable state. The first stationary state comprises the distal ends of plurality of arms with the plurality of the wheels extending upward and away from the surface and the base assembly adjacent to the surface, and the second moving state comprises the distal ends of plurality of arms with the plurality of the wheels abutting the surface and the base assembly being spaced apart from the surface.

Yet another aspect is directed to a method for making an umbrella assembly comprising providing an umbrella, and coupling the umbrella into a stand for moving the umbrella on a surface. The stand includes a base assembly to receive the umbrella and being over the surface, and a plurality of arms, each arm having a proximal end coupled to the base assembly, and a distal end extending outwardly from the base assembly. The stand also includes a plurality of wheels respectively coupled to the distal ends of the plurality of arms, and a plurality of supports coupled to the base assembly and extending outwardly from the base assembly, each of the plurality of supports comprises a pivot point for a respective one of the plurality of arms. The stand comprises an actuator assembly coupled to the base assembly and configured to cause the base assembly to switch between a first stationary state and a second movable state. The first stationary state comprises the distal ends of plurality of arms with the plurality of the wheels extending upward and away from the surface and the base assembly adjacent to the surface, and the second moving state comprises the distal ends of plurality of arms with the plurality of the wheels abutting the surface and the base assembly being spaced apart from the surface.

### BRIEF DESCRIPTION OF THE DRAWINGS

FIG. 1 is a perspective view of a stand with an umbrella inserted, according to a first embodiment of the present disclosure.

FIG. 2 is another perspective view of the stand from FIG. 1 with anchor weights spaced apart.

FIG. 3 is a perspective view of the stand from FIG. 1 in the second moving state.

FIG. 4 is a perspective view of the stand from FIG. 1 in the first stationary state.

FIG. 5A is an exploded view of the stand from FIG. 1.

FIG. 5B is an enlarged exploded view of the stand from FIG. 1.

FIG. 6 a cross-sectional view of the stand from FIG. 1 along line 6-6 of FIG. 4.

FIG. 7 is a perspective view of an actuator assembly of the stand from FIG. 1.

FIG. 8 is a perspective view of the actuator assembly and a base assembly (exploded) of the stand from FIG. 1.

FIG. 9 is a perspective view of a lift joint of the stand from FIG. 1.

FIGS. 10 & 11 are perspective views of the stand with the anchor weight removed and placed, respectively, according to a second embodiment of the present disclosure.

FIG. 12 is a perspective view of the stand with the anchor weight removed, according to a third embodiment of the present disclosure.

FIG. 13A is an exploded view of the stand from FIG. 12.

FIG. 13B is an enlarged exploded view of the stand from FIG. 12.

FIG. 14 is a perspective view of the base assembly and the actuator assembly of the stand from FIG. 12.

FIG. 15 is an exploded view of the base assembly and the actuator assembly of the stand from FIG. 12.

FIGS. 16A and 16B are cross-sectional views of the stand from FIG. 12 along line 16-16 in the second moving state and the first stationary state, respectively.

FIGS. 17A and 17B are enlarged cross-sectional views of the stand from FIG. 12 along line 16-16.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

To address the above issues, the present disclosure may provide a lifting and moving umbrella stand, optimizing the design using a pedal structure to facilitate the lifting operation of the umbrella stand, thereby improving usability and stability. A lifting and moving umbrella stand, comprising a base seat. The base seat includes a base frame and a lifting mechanism. The base frame includes a central base and supports extending outward from the central base. The lifting mechanism comprises a driving mechanism, a lifting base, and a lever. A pulley assembly is provided at the outer end of the lever, and the lever cooperates with the support as a lever. The driving mechanism includes an operating element, an expansion driving element, and a lifting arm. The operating element is used to control the expansion driving element to achieve expansion. The expansion driving element holds the lifting arm in a raised or lowered state when idle. The other end of the lifting arm is used to cooperate with the lifting base, enabling the lifting base to be in a raised or lowered state. One end of the lever is installed in conjunction with the lifting base. When the lifting base is in a raised state, the pulley assembly at the other end of the lever contacts the ground to separate the base seat from the ground; when the lifting base is in a lowered state, the pulley assembly at the other end of the lever lifts to cause the base seat to contact the ground.

The central base includes a central base seat, a central upper base seat, a central slide rod, and several support rods. The central slide rod is located between the central base seat and the central upper base seat. The lifting base is mounted on the central slide rod and can slide up and down along the central slide rod. Several support rods are used to support the central upper base seat.

The lifting base comprises a lifting base body, a lever suspension ear, and a docking seat. A single lever corresponds to a single lever suspension ear for hinged cooperation. The docking seat is used for installation in conjunction with the lifting arm.

The driving mechanism also includes a driving base. The lifting arm comprises a lifting end, a lifting arm body, a lifting pivot part, and a lifting movable part. The lifting end is used to install in conjunction with the docking seat. The lifting pivot part is used to hinge and cooperate with the driving base. The lifting movable part is used to install in conjunction with the expansion driving element.

The expansion driving element adopts any one of an oil cylinder, an air cylinder, or an electric cylinder. The operating element adopts a pedal assembly. The pedal assembly includes a foot pedal, a reset spring, and a switch portion. The switch portion is used to control the start or stop of the expansion driving element. The foot pedal adopts an integral or folding structure.

The support includes support rods, a support base, and a frame base. One end of the support rod is used to fixedly match the central base seat. The support base is fixed to the outer end of the support rod. A hanger is provided on the support base. The middle part of the lever is used to hinge and cooperate with the hanger. The frame base includes two frame base units. A reinforcing rod is provided between adjacent frame base units on the same side. An umbrella stand counterweight is arranged on the upper part of the base seat. The umbrella stand counterweight covers the base seat. The umbrella stand counterweight includes at least two umbrella stand counterweight units.

The base seat adopts a detachable and split structure. The central base seat and the central upper base seat are detachably fixedly installed through support rods. The support rod and the central base seat are detachably fixedly installed. The support base and the support rod are detachably fixedly installed. The lever and the hanger are detachably hinged. The reinforcing rod and the frame base unit are detachably fixedly installed.

The base seat adopts a welded fixed structure. The central base seat and the central upper base seat are welded and fixed through support rods. The support rod and the central base seat are welded and fixed. The support base and the support rod are welded and fixed. The reinforcing rod and the frame base unit are welded and fixed.

Compared with the prior art, the present disclosure has the following beneficial effects: optimizing the driving mechanism, combined with the lifting or lowering of the lifting base, can control the lever to achieve lifting, placement, or lowering movement of the roller assembly; optimizing the driving mechanism to facilitate pedal operation, improving operational convenience; and optimizing the base seat structure can form a split or integral structure, making it more adaptable.

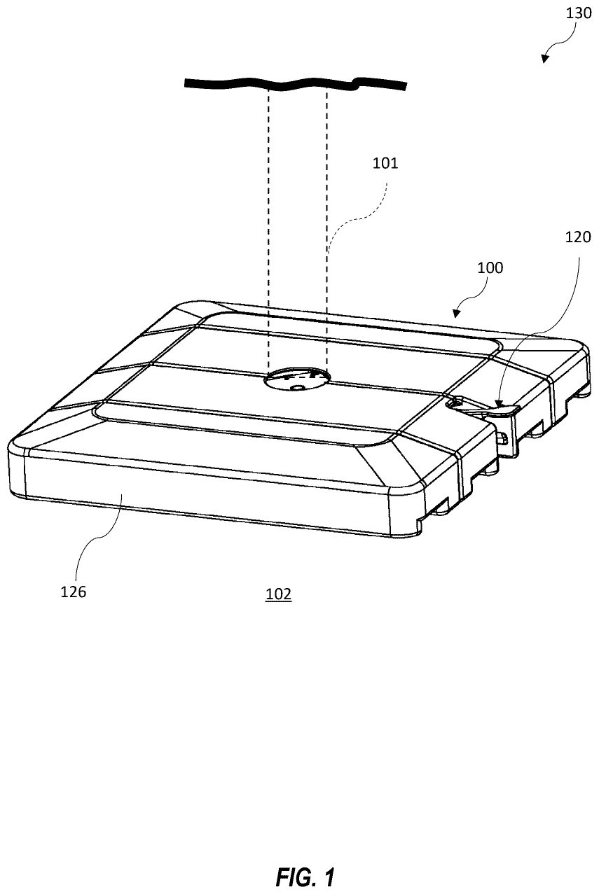

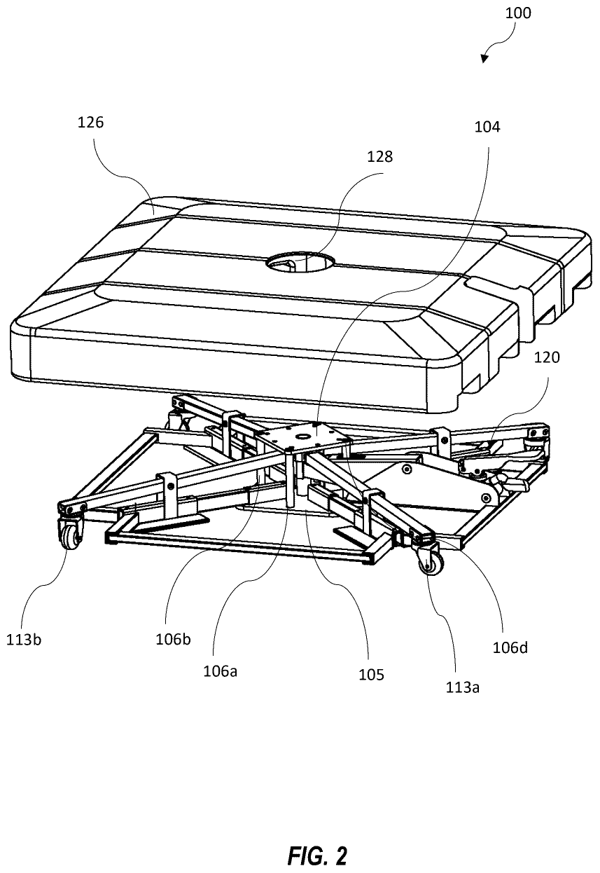

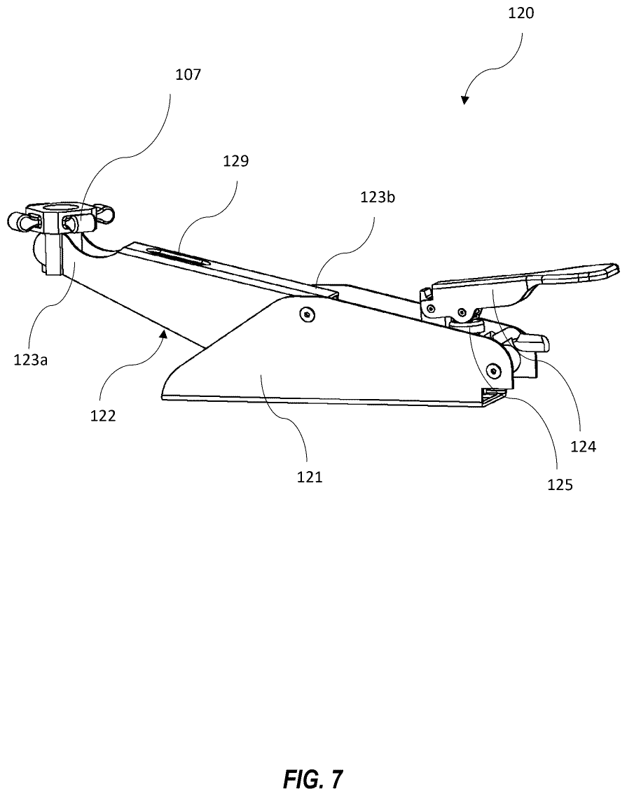

Referring to FIGS. 1 to 11, the present disclosure discloses a lifting and movable umbrella stand, comprising a base seat. An umbrella stand counterweight unit is arranged on the upper part of the base seat. The umbrella stand counterweight unit covers the base seat and includes at least two umbrella stand counterweight units. In one embodiment, the umbrella stand counterweight unit includes four umbrella stand counterweight units arranged in a rectangular layout. This layout helps reduce the overall packaging volume, facilitating product logistics transportation, especially when combined with the umbrella body for transportation. It can be assembled as a whole. The umbrella stand counterweight unit is usually made of plastic injection molding and preferably has a hollow structure inside to be filled with water, sand, or other materials to form an integral counterweight.

The base seat includes a base frame and a lifting mechanism. The base frame comprises a central base and support brackets extending outward from the central base. The base frame forms an integral frame foundation, serving as the overall support structure. The lifting mechanism is typically used to lift or lower the base frame, causing it to detach or contact the ground.

The lifting mechanism includes a driving mechanism, a lifting base, and a lever. The lever is provided with a pulley component at its outer end and cooperates with the support bracket as a lever. The driving mechanism comprises an operating component, an expansion driving element, and a lifting arm. The operating component controls the expansion driving element to expand or retract. When the expansion driving element is idle, the lifting arm is in a raised or lowered state. The other end of the lifting arm cooperates with the lifting base, enabling the lifting base to be in a raised or lowered state. One end of the lever is installed in cooperation with the lifting base. When the lifting base is in a raised state, the pulley component at the other end of the lever contacts the ground, causing the base seat to detach from the ground. When the lifting base is in a lowered state, the pulley component at the other end of the lever lifts, causing the base seat to contact the ground.

Combining the above structure, the expansion driving element can be controlled by the operating component. The operating component can have different structures in different embodiments, utilizing a pedal assembly for ease of operation. The pedal structure facilitates operational control, making it convenient for users to operate. Alternatively, a lever or push rod structure can be used.

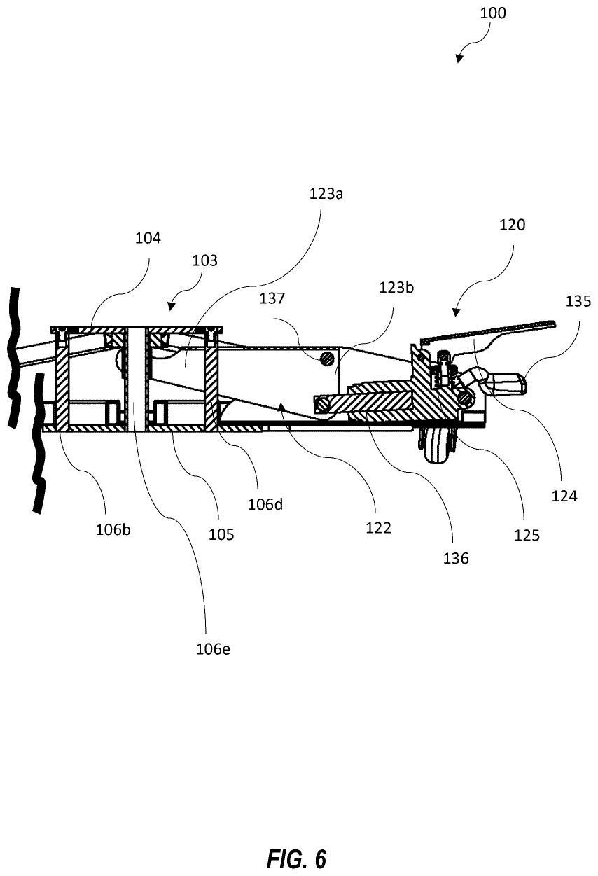

In one embodiment, as shown in FIG. 6, the operating component adopts a pedal assembly. The pedal assembly includes a pedal, a reset spring, and a switch part. The switch part is used to control the startup or shutdown of the expansion driving element. One end of the pedal is hinged and cooperates with the base of the expansion driving element. The lower part of the pedal is equipped with a reset spring, which contacts the switch part. When the pedal is stepped on, the switch part is depressed, aligning with the drive switch in the expansion driving element, thus controlling the opening of the expansion driving element. A second step on the pedal enables the closing control of the expansion driving element.

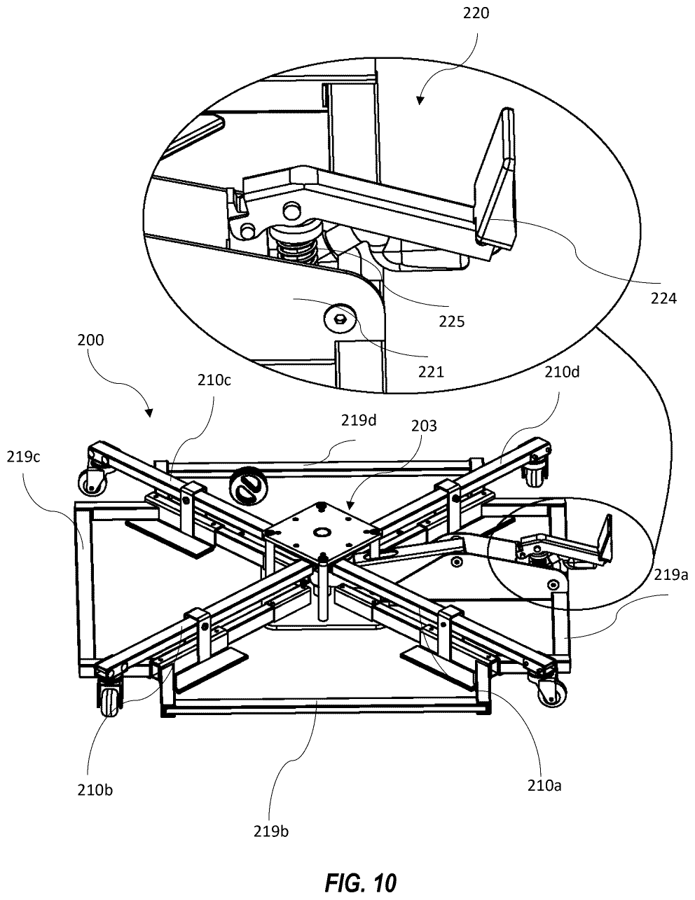

In another embodiment, the operating component also includes a pressure relief handle, which directly cooperates with the expansion driving element. The pedal assembly controls the extension of the expansion driving element, i.e., the lifting status control of the lifting arm, while the pressure relief handle controls the exhaust of the expansion driving element, i.e., the lowering status control of the lifting arm. In this embodiment, the expansion driving element usually adopts a hydraulic cylinder. The pedal may be of integral structure. In another embodiment, as shown in FIGS. 10 and 11, the pedal may also have a folding structure to reduce the overall packaging volume.

When the expansion driving element uses a pneumatic cylinder, the pedal can be kept in a stepped state. By depressing the switch part, which aligns with the drive switch in the expansion driving element, the expansion driving element is activated, and the pneumatic cylinder extends, causing the lifting arm to lift. Then, the pedal is reset to lock the status. If the lifting arm needs to be in the lowered state, a second step on the pedal maintains the stepped state. By pressing down the other end of the lifting arm, the pneumatic cylinder is reset. Then, the pedal is reset to lock the status.

When the expansion driving element uses an electric cylinder, the number of steps or the cycle time of stepping on the pedal can be used as a limit. By depressing the switch part, which aligns with the drive switch in the expansion driving element, the expansion driving element is activated, and the electric cylinder extends or retracts, causing the lifting arm to lift or lower. The electric cylinder is a commonly used component in existing technology, which integrates the motor with the lead screw to convert the rotational motion of the motor into linear motion.

Combining the above, the central base includes a central base, a central upper base, a central slide rod, and several support rods. The central slide rod is located between the central base and the central upper base, and the lifting base is fitted on the central slide rod and can slide up and down along it. Several support rods are used to support the central upper base. The central base is located in the center of the entire umbrella stand. The central upper base is used to support and fix the umbrella pole or rotating umbrella stand, while the central base serves as the bottom surface to contact the ground. The central slide rod is used in conjunction with the lifting base to facilitate the movement of the lifting base, allowing it to drive the lever arm to complete the lever motion.

Furthermore, the lifting base includes a lifting base body, a lever arm suspension lug, and a docking seat. Each lever arm corresponds to a lever arm suspension lug for hinged cooperation, and the docking seat is used to install and match the lifting arm. The drive mechanism also includes a drive base. The lifting arm includes a lifting end, a lifting arm body, a lifting fulcrum portion, and a lifting active portion. The lifting end is used to cooperate and install with the docking seat. The lifting fulcrum portion is used for hinged cooperation with the drive base, and the lifting active portion is used to cooperate and install with the telescopic drive member.

When the telescopic drive member drives the lifting active portion to move, usually extending towards the center, the lifting end moves upward due to the lever fulcrum structure formed by the lifting fulcrum portion, completing the lifting of the lifting base. As the lifting base moves upward along the central slide rod, the end of the lever arm hinged with the lever arm suspension lug moves upward, causing the lever arm to lever, and the pulley member at the other end of the lever arm moves downward until it contacts the bottom surface, completing the lifting of the entire base frame, and the umbrella stand can be moved using the pulley member. When the telescopic drive member drives the lifting active portion to return, usually retracting outwards, combined with the lever fulcrum structure formed by the lifting fulcrum portion, the lifting end moves downward, completing the descent of the lifting base. As the lifting base moves downward along the central slide rod, the end of the lever arm hinged with the lever arm suspension lug moves downward, causing the lever arm to lever, and the pulley member at the other end of the lever arm moves upward until the pulley member is separated from the ground, and the entire base frame completes the contact with the ground, and the umbrella stand is in a stationary state.

Moreover, the support includes a support rod, a support base, and a frame base. One end of the support rod is used to cooperate and fix with the central base, and the support base is fixed to the outer end of the support rod. The support base is provided with a suspension lug, and the middle of the lever arm is used to cooperate and hinge with the suspension lug. The frame base includes two frame base units, and adjacent frame base units on the same side are matched with reinforcing rods. Optimizing the structure of the support facilitates lever cooperation with the lever arm, while also providing good support and optimizing the design of the reinforcing rods to increase overall strength, making it convenient for the umbrella stand weight to be installed.

This present disclosure optimizes the drive mechanism, combined with the lifting or lowering of the lifting base, to control the lever arm, thereby completing the lifting, placement, or lowering movement of the roller member. The optimized drive mechanism facilitates foot operation, improving operational convenience.

In some embodiments of the movable umbrella stand, the base seat adopts a detachable and separable structure. The central base seat and the central upper seat are connected by support rods for detachable fixation. The support rod and the central base seat are assembled with detachable fixation, as well as the support base and the support rod. The lever arm is connected to the hanger with detachable hinge installation, and the reinforcement rod and the frame base unit are fixed with detachable installation. Typically, fasteners such as screws or bolts are used, with support rods having threaded sockets at both ends for securing the central base seat and the central upper seat with bolts. Threaded hole structures are provided correspondingly between components for easy fixation with fasteners.

Optimizing the structure of the base seat allows for a split structure, enhancing product adaptability. The entire umbrella stand can be disassembled for convenient packaging with sunshades, reducing packaging volume and overall logistics costs, with easy assembly of this structure.

In other embodiments, the base seat adopts a welded fixed structure. The central base seat and the central upper seat are welded fixedly with support rods, while the support rod and the central base seat are welded fixedly, as well as the support base and the support rod. The reinforcement rod and the frame base unit are welded fixedly. Optimizing the structure of the base seat results in an integrated welded fixed structure with good stability, suitable for independent product sales.

A lifting and moving umbrella stand, comprising a base seat, characterized in that: the base seat includes a base frame and a lifting mechanism, wherein the base frame comprises a central base and supports extending outward from the central base, and the lifting mechanism includes a driving mechanism, a lifting base, and a lever. A pulley assembly is provided at the outer end of the lever, and the lever cooperates with the support as a lever. The driving mechanism comprises an operating element, an expansion driving element, and a lifting arm; the operating element is used to control the expansion driving element to achieve expansion, and the expansion driving element holds the lifting arm in a raised or lowered state when idle. The other end of the lifting arm is used to cooperate with the lifting base, enabling the lifting base to be in a raised or lowered state. One end of the lever is installed in conjunction with the lifting base. When the lifting base is in a raised state, the pulley assembly at the other end of the lever contacts the ground, separating the base seat from the ground; when the lifting base is in a lowered state, the pulley assembly at the other end of the lever lifts, causing the base seat to contact the ground.

A lifting and moving umbrella stand, characterized in that: the central base comprises a central base seat, a central upper base seat, a central slide rod, and several support rods, wherein the central slide rod is located between the central base seat and the central upper base seat. The lifting base is mounted on the central slide rod and can slide up and down along the central slide rod, and several support rods are used to support the central upper base seat. A lifting and moving umbrella stand, characterized in that: the lifting base comprises a lifting base body, a lever suspension ear, and a docking seat, wherein a single lever corresponds to a single lever suspension ear for hinged cooperation, and the docking seat is used for installation in conjunction with the lifting arm. A lifting and moving umbrella stand, characterized in that: the driving mechanism further comprises a driving base, the lifting arm comprises a lifting end, a lifting arm body, a lifting fulcrum portion, and a lifting movable portion, wherein the lifting end is used for installation in conjunction with the docking seat, the lifting fulcrum portion is used for hinged cooperation with the driving base, and the lifting movable portion is used for installation in conjunction with the expansion driving element.

A lifting and moving umbrella stand, characterized in that: the expansion driving element adopts any one of an oil cylinder, an air cylinder, or an electric cylinder. A lifting and moving umbrella stand, characterized in that: the operating element adopts a pedal assembly, wherein the pedal assembly includes a foot pedal, a reset spring, and a switch portion, the switch portion being used to control the start or stop of the expansion driving element, and the foot pedal adopts an integral or folding structure.

A lifting and moving umbrella stand, characterized in that: the support comprises support rods, a support base, and a frame base, wherein one end of the support rod is fixedly matched with the central base seat, the support base is fixed to the outer end of the support rod, a hanger is provided on the support base, the middle part of the lever is hinged to cooperate with the hanger, and the frame base comprises two frame base units, adjacent frame base units on the same side are reinforced with a reinforcing rod. A lifting and moving umbrella stand, characterized in that: an umbrella stand counterweight is arranged on the upper part of the base seat, wherein the umbrella stand counterweight covers the base seat, and the umbrella stand counterweight comprises at least two umbrella stand counterweight units.

A lifting and moving umbrella stand, characterized in that: the base seat adopts a detachable and split structure, the central base seat and the central upper base seat are detachably fixedly installed through support rods, the support rod is detachably fixedly installed with the central base seat, the support base and the support rod are detachably fixedly installed, the lever is detachably hinged with the hanger, and the reinforcing rod and the frame base unit are detachably fixedly installed. A lifting and moving umbrella stand, characterized in that: the base seat adopts a welded fixed structure, the central base seat and the central upper base seat are welded and fixed through support rods, the support rod is welded and fixed with the central base seat, the support base and the support rod are welded and fixed, and the reinforcing rod and the frame base unit are welded and fixed.

These present embodiments provide for a lifting and moving umbrella stand, comprising a base seat. The base seat includes a base frame and a lifting mechanism. The base frame includes a central base and supports extending outward from the central base. The lifting mechanism comprises a driving mechanism, a lifting base, and a lever. A pulley assembly is provided at the outer end of the lever, which cooperates with the support as a lever. The driving mechanism comprises an operating element, an expansion driving element, and a lifting arm. The operating element is used to control the expansion driving element to achieve expansion. When the expansion driving element is idle, the lifting arm is in a raised or lowered state. The other end of the lifting arm is used to cooperate with the lifting base, enabling the lifting base to be in a raised or lowered state. This embodiment optimizes the driving mechanism, combined with the lifting or lowering of the lifting base, to control the lever, thereby completing the lifting or lowering movement of the roller assembly. Optimizing the driving mechanism facilitates foot-operated operation and improves operational convenience.

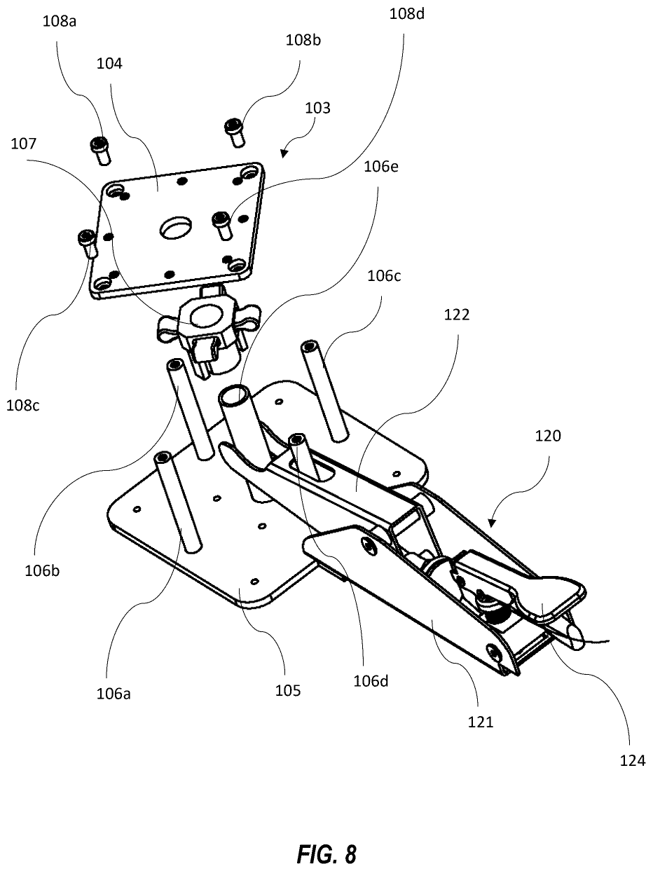

Referring now to FIGS. 1-9, an umbrella assembly 130 according to the present disclosure is now described. The umbrella assembly 130 illustratively comprises an umbrella 101, and a stand 100 for moving the umbrella on a surface 102. The stand 100 comprises a base assembly 103. The base assembly 103 illustratively includes an upper platform 104 to receive the umbrella 101, a lower platform 105 under the upper platform and over the surface 102, a plurality of legs 106a-106e extending between the upper platform and the lower platform, and a lift joint 107 between the upper platform and the lower platform. In particular, the plurality of legs 106a-106e comprises four corner legs 106a-106d coupled at diagonal corners of the upper platform 104 and the lower platform 105, and a central leg 106e carrying the lift joint 107. As perhaps best seen in FIG. 8, the base assembly 103 is illustratively coupled together with a plurality of fasteners 108a-108d, but in other embodiments, the components may be welded together, or may be integrally formed.

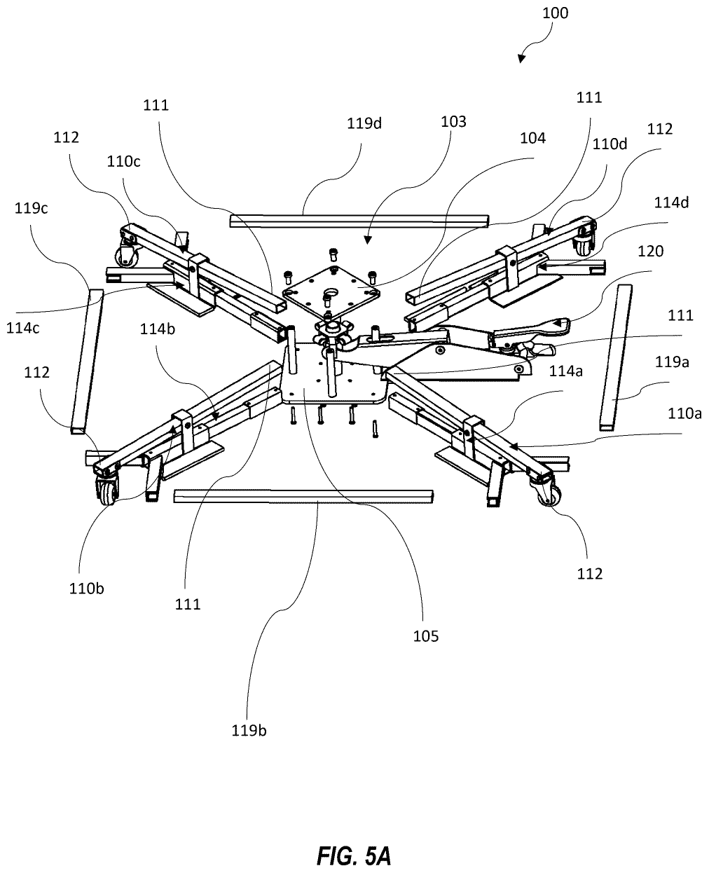

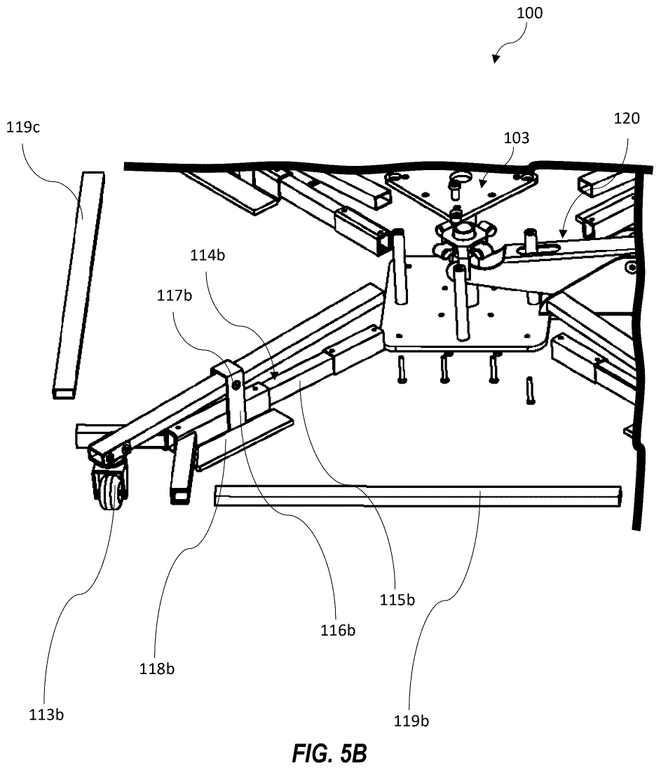

The stand 100 further includes a plurality of arms 110a-110d. As perhaps best seen in FIG. 5A, each arm 110a-110d has a proximal end 111 coupled to the lift joint 107, and a distal end 112 extending outwardly from the base assembly 103. The stand 100 also includes a plurality of wheels 113a-113d respectively coupled to the distal ends 112 of the plurality of arms 110-110d. Each of the plurality of wheels 113a-113d illustratively comprises a caster style wheel.

As perhaps best seen in FIG. 5B, the stand 100 illustratively includes a plurality of supports 114a-114d coupled to the lower platform 105 and extending outwardly from the base assembly 103. Each of the plurality of supports 114a-114d comprises a lower arm 115a-115d below and aligned with a respective one of the plurality of arms 110a-110d, a transverse arm 116a-116d coupled to a medial part of the lower arm and extending transversely upward, and a lateral flange 118a-118d extending laterally from the lower arm. The transverse arm 116a-116d comprises a pivot point 117a-117d for the respective one of the plurality of arms 110a-110d. Also, the stand 100 illustratively includes a plurality of peripheral supports 119a-119d respectively coupled between the plurality of supports 114a-114d.

The stand 100 includes an actuator assembly 120 coupled between the lift joint 107 and a respective peripheral support 119a. The actuator assembly 120 is also coupled to the lower platform 105. In particular, the actuator assembly 120 illustratively comprises a housing 121, and a lever 122. The lever 122 illustratively includes a first end 123a coupled to the lift joint 107 of the base assembly 103, a second end 123b, and a medial opening 129 between the first end and the second end and receiving the respective leg 106d. The actuator assembly 120 also illustratively includes an actuator device 124 coupled to the second end of the lever, a reset elastic device 125 (e.g., a spring) coupled to the actuator device, and a release device 135.

In the illustrated embodiment, the actuator device 124 comprises a foot pedal. For example, the actuator device 124 illustratively includes a pneumatic device 136 coupled to the foot pedal (e.g., hydraulic strut) and aiding the movement of the lever 122. In the illustrated embodiment, the pneumatic device 136 is coupled to the second end 123b of the lever 122 and pivots the lever about a lever pivot point 137.

As perhaps best seen in FIG. 1, the stand 100 illustratively includes an anchor weight 126 over the base assembly 103 and the plurality of arms 110a-110d. As will be appreciated, the anchor weight 126 provides a counterweight to forces urging the umbrella 101 to tip, for example, wind. The anchor weight 126 may comprise a housing storing sand or a fluid, such as water, for example. The anchor weight 126 defines an opening 128 for receiving the umbrella 101.

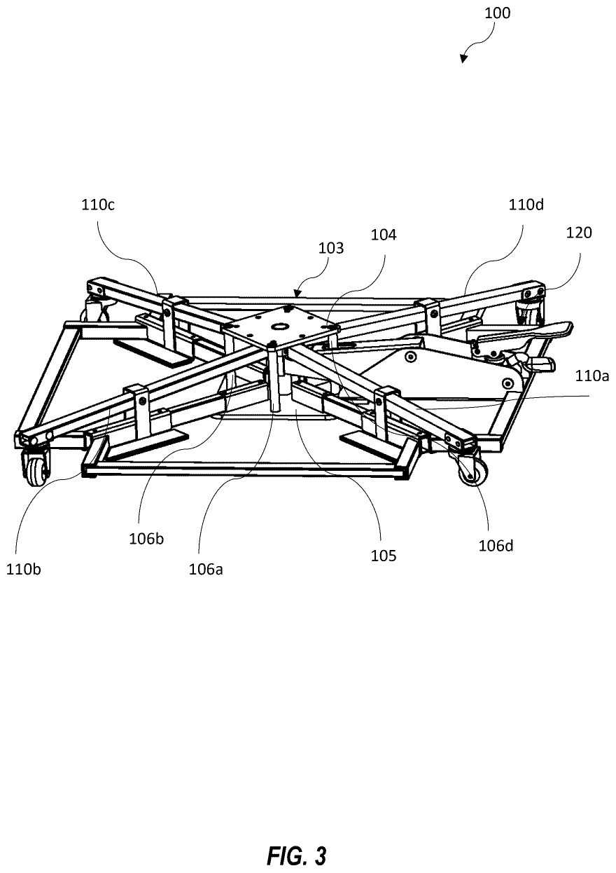

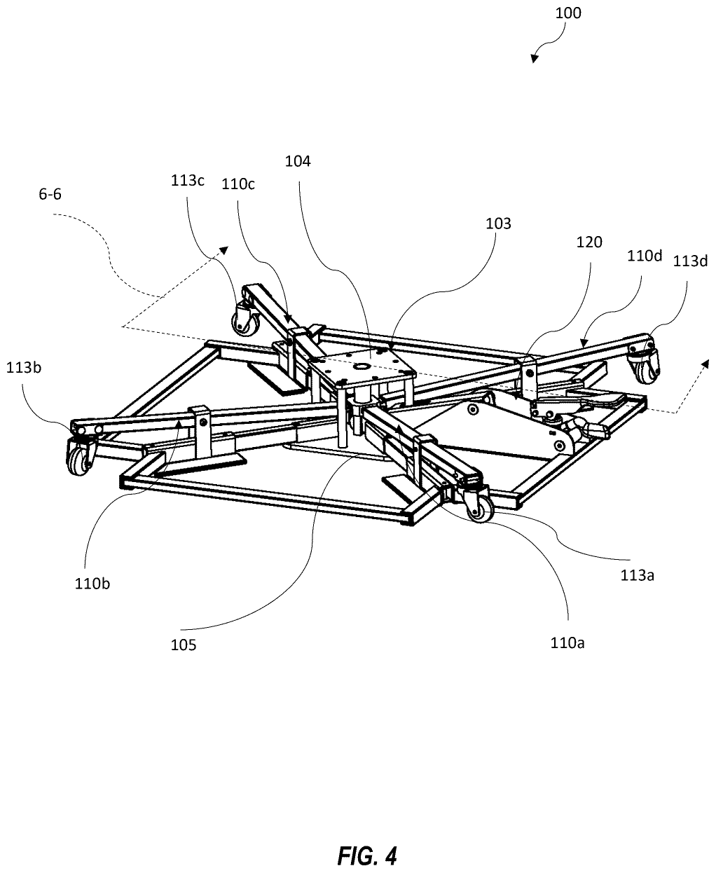

As perhaps best seen in FIGS. 3-4, the actuator assembly 120 is configured to cause the lift joint 107 to switch between a first stationary state (FIG. 4) and a second movable state (FIG. 3) by sliding the lift joint along the central leg 106e. In the first stationary state, the distal ends 112 of plurality of arms 110a-110d and the plurality of the wheels 113a-113d are extending upward and away from the surface 102. Further, one or more of the lower platform 105, the lateral flange 118a-118d, and the plurality of peripheral supports 119a-119d abut the surface 102, providing a secure foundation for the stand 100.

In the second moving state, the distal ends 112 of plurality of arms 110a-110d are adjacent to the surface 102 and the plurality of the wheels 113a-113d is abutting the surface, and the lower platform 105 is spaced apart from the surface. Here, a user may easily manipulate the stand 100 to move omnidirectionally on the surface 102.

In particular, to move the stand 100, the user would depress the foot pedal of the actuator device 124, which causes the first end 123a of the lever 122 and the lift joint 107 to rise along the central leg 106e. This is accomplished by the user activating/pumping the pneumatic device 136, which pivots the lever 122 about the lever pivot point 137. Further, the reset elastic device 125 biases the foot pedal upward so that the user may repeatedly pump the foot pedal and lift the base assembly 103 and the anchor weight 126.

This causes each of the plurality of arms 110a-110d to pivot about the pivot point 117a-117d for switching between the first stationary state and the second moving state. Here, the distal ends of the plurality of arms 110a-110d move toward the surface 102, causing the plurality of wheels 113a-113d to contact the surface. As will be appreciated, when the user depresses the actuator device 124. When the user is satisfied with the position of the stand 100, the user activates the release device 135 of the actuator device 124, which causes the pneumatic device 136 to release pressure and return the actuator assembly 120 to the rest state (i.e., first stationary state).

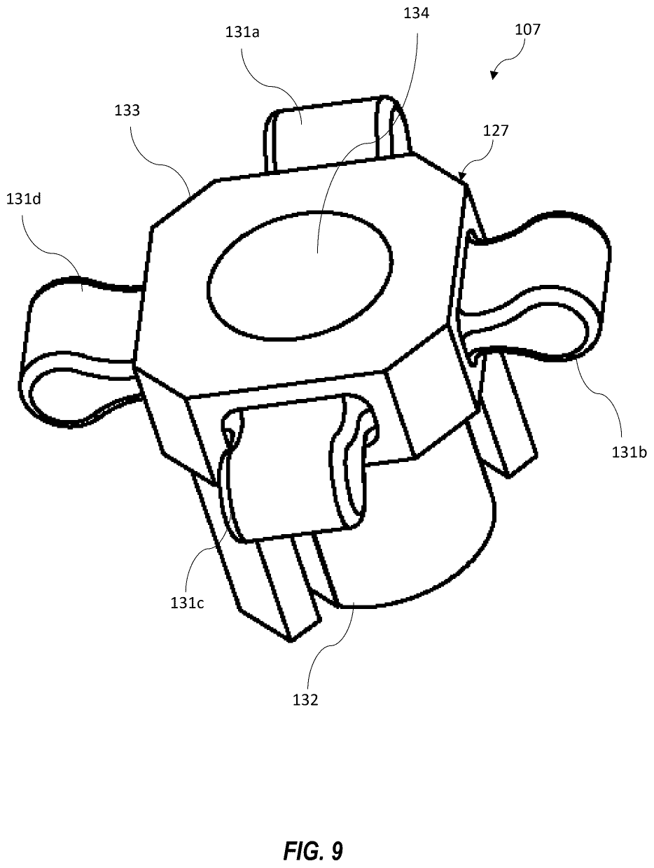

Referring now to FIG. 9, the lift joint 107 illustratively includes a joint housing 127, and a plurality of tongues 131a-131d carried by the joint housing and being respectively received by the proximal ends 111 of the plurality of arms 110a-110d. The joint housing 127 illustratively comprises a lower interface 132, a longitudinal passageway 134 to receive the central leg 106e, and an upper interface 133 to but the upper platform 104 in the second movable state.

Yet another aspect is directed to a method for making an umbrella assembly 130 comprising providing an umbrella 101, and coupling the umbrella into a stand 100 for moving the umbrella on a surface 102. The stand 100 includes a base assembly 103 to receive the umbrella 101 and being over the surface 102, and a plurality of arms 110a-110d, each arm having a proximal end 111 coupled to the base assembly, and a distal end 112 extending outwardly from the base assembly. The stand 100 also includes a plurality of wheels 113a-113d respectively coupled to the distal ends 112 of the plurality of arms 110a-110d, and a plurality of supports 114a-114d coupled to the base assembly 103 and extending outwardly from the base assembly, each of the plurality of supports comprises a pivot point 117a-117d for a respective one of the plurality of arms. The stand 100 comprises an actuator assembly 120 coupled to the base assembly 103 and configured to cause the base assembly to switch between a first stationary state and a second movable state. The first stationary state comprises the distal ends 112 of plurality of arms 110a-110d with the plurality of the wheels 113a-113d extending upward and away from the surface 102 and the base assembly 103 being adjacent to or in some embodiments abutting the surface, and the second moving state comprises the distal ends of plurality of arms with the plurality of the wheels abutting the surface and the base assembly being spaced apart from the surface.

Referring now additionally to FIGS. 10-11, another embodiment of the stand 200 is now described. In this embodiment of the stand 200, those elements already discussed above with respect to FIGS. 1-9 are incremented by 100 and most require no further discussion herein. This embodiment differs from the previous embodiment in that this stand 200 comprises an actuator assembly 220 with a folding actuator device 224. In particular, the foot pedal of this embodiment may fold when the actuator assembly 220 is in the first stationary state.

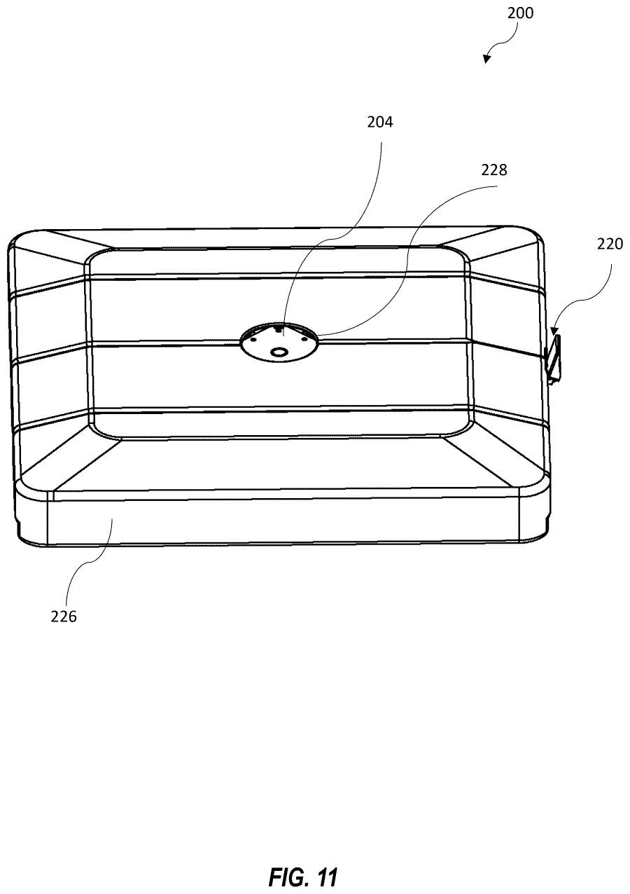

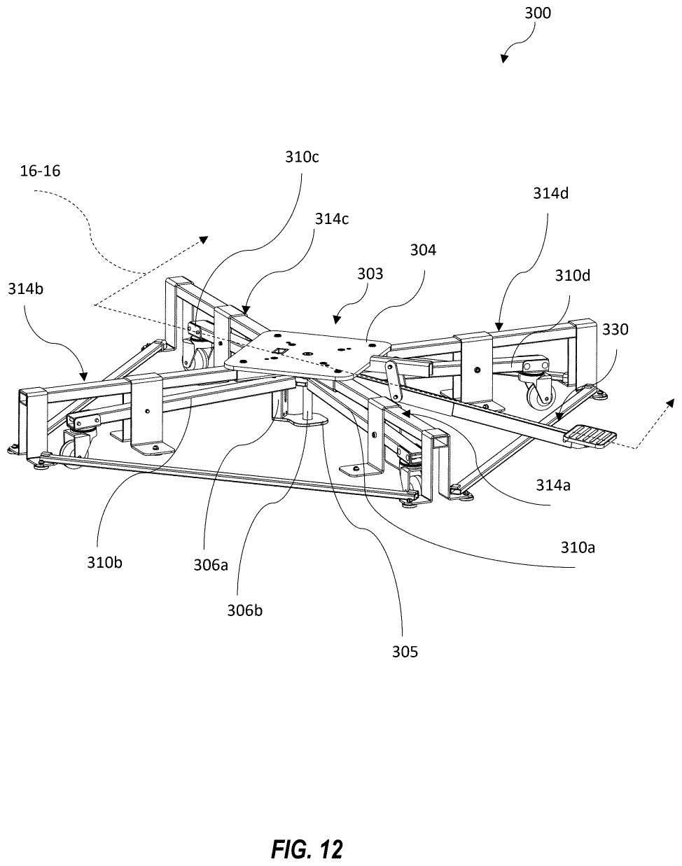

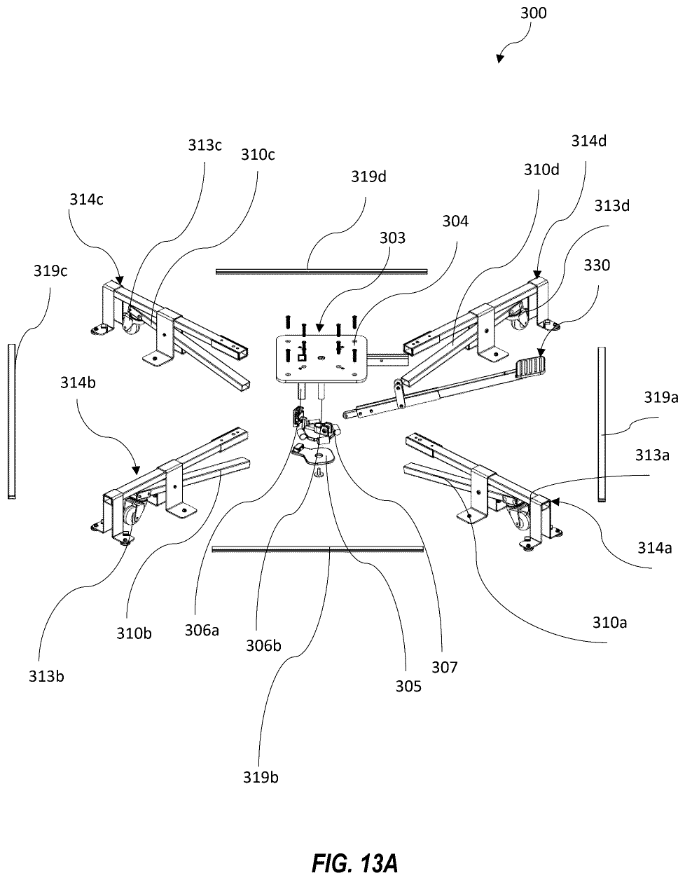

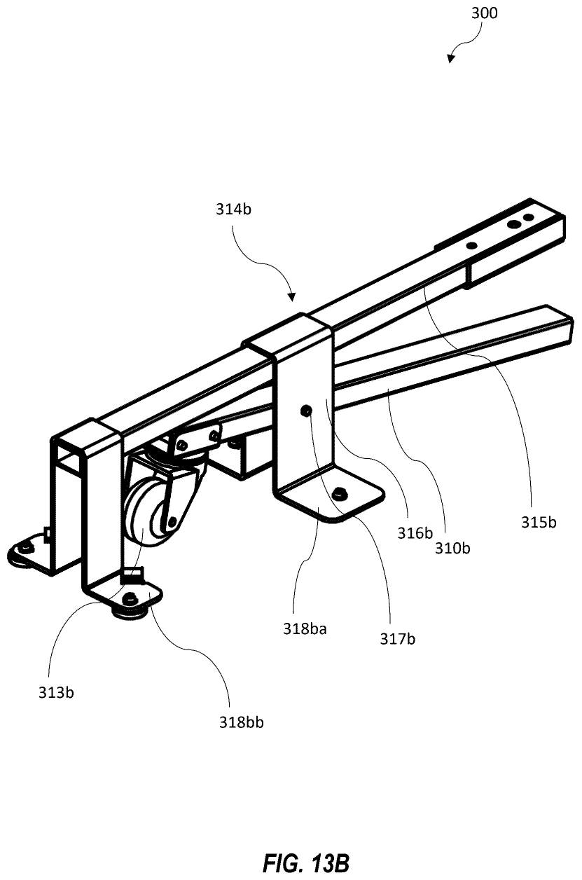

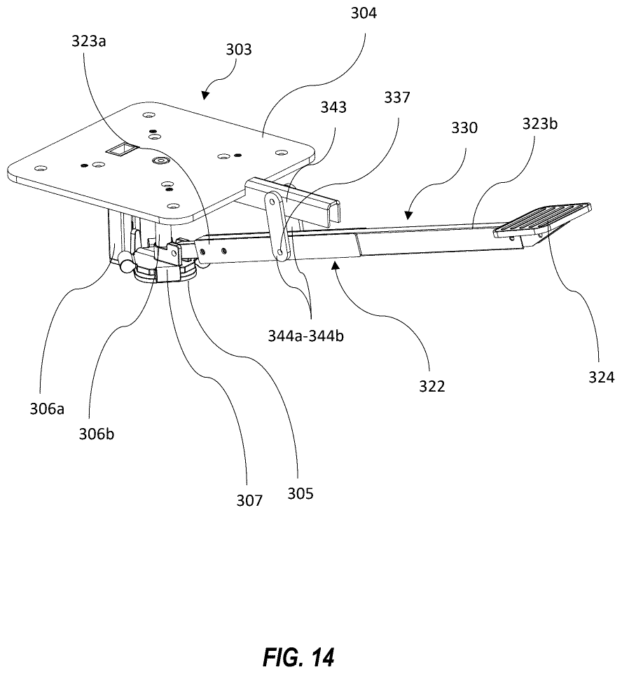

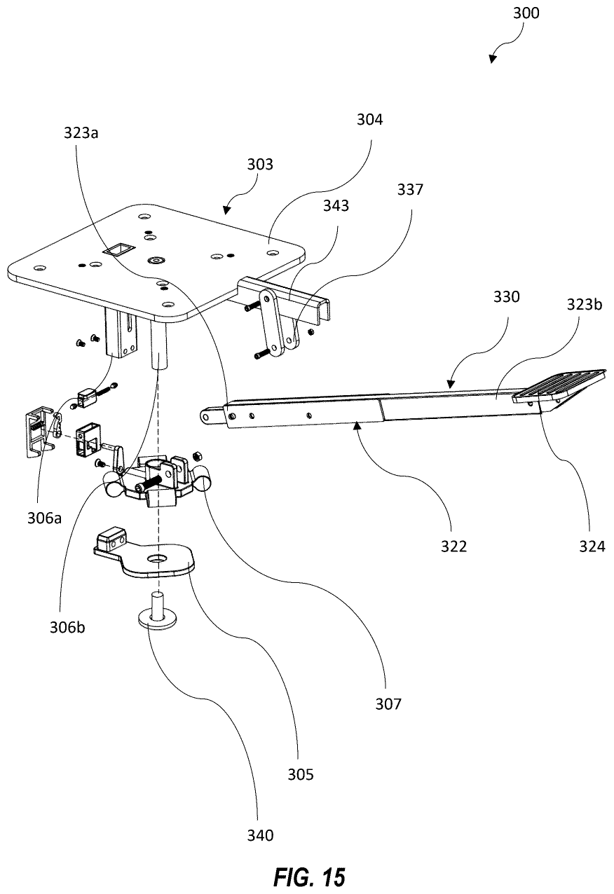

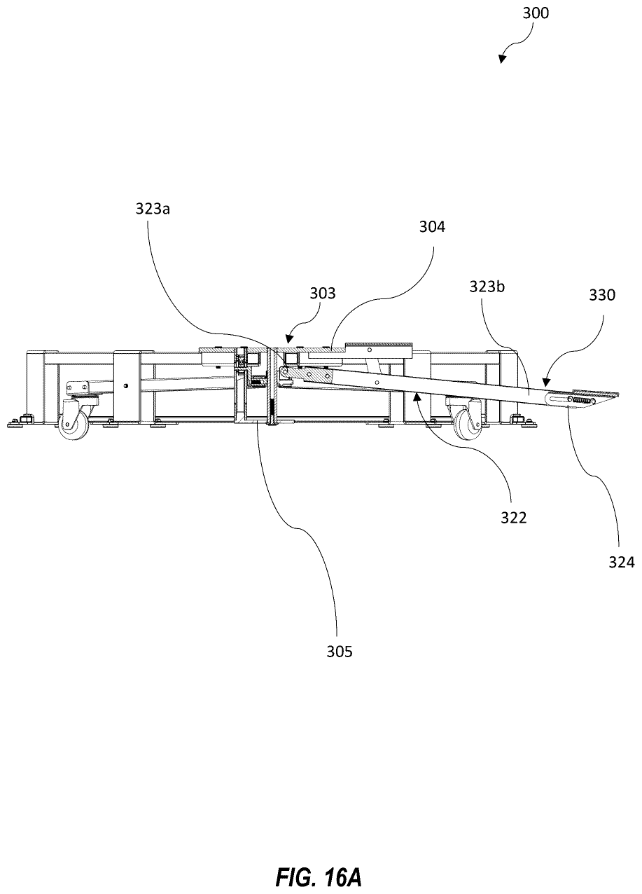

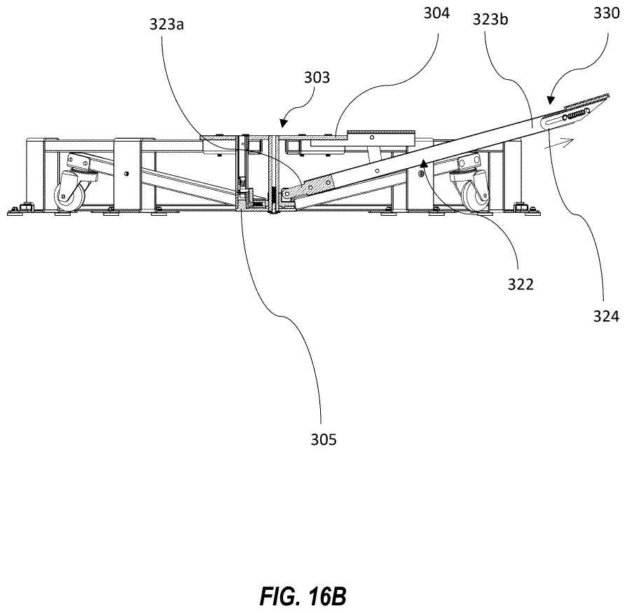

Referring now additionally to FIGS. 12-17B, another embodiment of the stand 300 is now described. In this embodiment of the stand 300, those elements already discussed above with respect to FIGS. 1-9 are incremented by 200 and most require no further discussion herein. This embodiment differs from the previous embodiment in that this stand 300 has swapped the vertical position/arrangement of the plurality of arms 310a-310d and the plurality of supports 314a-314d. Here, each respective support 314a-314d sits above and aligned with each respective arm 310a-310d. Each of the plurality of supports 314a-314d comprises an upper arm 315b above and aligned with a respective one of the plurality of arms 310a-310d, a transverse arm 316a-316d coupled to a medial part of the upper arm and extending transversely downward, and first and second lateral flanges 318ba, 318bb extending laterally from the upper arm. Each downwardly extending transverse arm 316a-316d provides a pivot point 317a-317d for the respective one of the plurality of arms 310a-310d. Further, in this embodiment, the base assembly 303 illustratively includes first and second legs 306a-306b, and the lift joint 307 slides along the second leg 306b. The upper platform 304 and the lower platform 305 are coupled together via both the first and second legs 306a-306b, and a fastener 340.

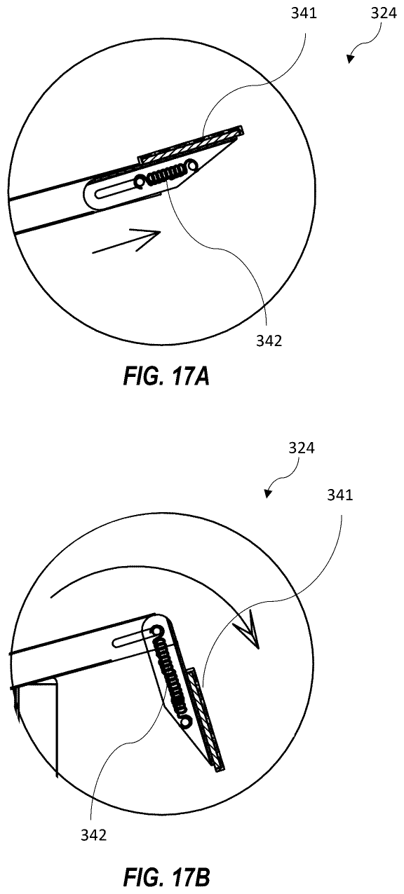

Also, the actuator assembly 320 has a simpler design. Here, the lever pivot 337 is provided via the upper platform 304. In particular, the lever pivot 337 comprises a lateral arm 343 extending from the upper platform 304, and first and second transverse arms 344a-344b coupled to the lateral arm and defining the lever pivot point 337. This actuator assembly 320 omits the pneumatic device and the reset elastic device of the prior embodiments for simple lever 322. In this embodiment and as perhaps best seen in FIGS. 17A-17B, the actuator device 324 (i.e., foot pedal) does fold for storage purposes. The actuator device 324 illustratively includes a pedal portion 341 slidingly coupled to the second end 323b of the lever 322, and an elastic device 342 configured to bias the pedal portion in a non-folded state so that the user can switch the stand 300 between the first stationary state and the second movable state. To stow the pedal portion 341, the user would pull the pedal portion outward and then fold it down.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A stand for moving an umbrella on a surface, the stand comprising:
a base assembly to receive the umbrella and being over the surface;
a plurality of arms, each arm having a proximal end coupled to the base assembly, and a distal end extending outwardly from the base assembly;
a plurality of wheels respectively coupled to the distal ends of the plurality of arms;
a plurality of supports coupled to the base assembly and extending outwardly from the base assembly, each of the plurality of supports comprises a pivot point for a respective one of the plurality of arms; and
an actuator assembly coupled to the base assembly and configured to cause the base assembly to switch between a first stationary state and a second movable state, the first stationary state comprising the distal ends of plurality of arms with the plurality of the wheels extending upward and away from the surface and the base assembly adjacent to the surface, the second moving state comprising the distal ends of plurality of arms with the plurality of the wheels abutting the surface and the base assembly being spaced apart from the surface.

2. The stand of claim 1 wherein the base assembly comprises an upper platform to receive the umbrella, a lower platform coupled to the upper platform, and a lift joint between the upper platform and the lower platform and coupled to the proximal ends of the plurality of arms.

3. The stand of claim 2 wherein the base assembly comprises a plurality of legs coupled between the upper platform and the lower platform.

4. The stand of claim 1 wherein the actuator assembly comprises a housing, a lever having a first end coupled to the base assembly and a second end, and an actuator device coupled to the second end of the lever.

5. The stand of claim 4 wherein the actuator device comprises a foot pedal.

6. The stand of claim 4 wherein the actuator device comprises a pneumatic device.

7. The stand of claim 1 further comprising a plurality of peripheral supports respectively coupled between the plurality of supports.

8. The stand of claim 1 further comprises an anchor weight over the base assembly and the plurality of arms.

9. The stand of claim 1 wherein each arm pivots on a respective support when switching between the first stationary state and the second movable state.

10. A stand for moving an umbrella on a surface, the stand comprising:
a base assembly comprising an upper platform to receive the umbrella, a lower platform under the upper platform and over the surface, a plurality of legs extending between the upper platform and the lower platform, and a lift joint between the upper platform and the lower platform;
a plurality of arms, each arm having a proximal end coupled to the lift joint, and a distal end extending outwardly from the base assembly;
a plurality of wheels respectively coupled to the distal ends of the plurality of arms;
a plurality of supports coupled to the base assembly and extending outwardly from the base assembly, each of the plurality of supports comprises a pivot point for a respective one of the plurality of arms;
an anchor weight over the base assembly and the plurality of arms; and
an actuator assembly coupled to the lift joint and configured to cause the lift joint to switch between a first stationary state and a second movable state, the first stationary state comprising the distal ends of plurality of arms with the plurality of the wheels extending upward and away from the surface and the lower platform adjacent to the surface, the second moving state comprising the distal ends of plurality of arms with the plurality of the wheels abutting the surface and the lower platform being spaced apart from the surface.

11. The stand of claim 10 wherein the actuator assembly comprises a housing, a lever having a first end coupled to the base assembly and a second end, and an actuator device coupled to the second end of the lever.

12. The stand of claim 11 wherein the actuator device comprises a foot pedal.

13. The stand of claim 11 wherein the actuator device comprises a pneumatic device.

14. The stand of claim 11 further comprising a plurality of peripheral supports respectively coupled between the plurality of supports.

15. The stand of claim 11 wherein each arm pivots on a respective support when switching between the first stationary state and the second movable state.

16. An umbrella assembly comprising:
an umbrella; and
a stand for moving the umbrella on a surface, the stand comprising
a base assembly to receive the umbrella and being over the surface,
a plurality of arms, each arm having a proximal end coupled to the base assembly, and a distal end extending outwardly from the base assembly,
a plurality of wheels respectively coupled to the distal ends of the plurality of arms,
a plurality of supports coupled to the base assembly and extending outwardly from the base assembly, each of the plurality of supports comprises a pivot point for a respective one of the plurality of arms, and
an actuator assembly coupled to the base assembly and configured to cause the base assembly to switch between a first stationary state and a second movable state, the first stationary state comprising the distal ends of plurality of arms with the plurality of the wheels extending upward and away from the surface and the base assembly adjacent to the surface, the second moving state comprising the distal ends of plurality of arms with the plurality of the wheels abutting the surface and the base assembly being spaced apart from the surface.

17. The umbrella assembly of claim 16 wherein the base assembly comprises an upper platform to receive the umbrella, a lower platform coupled to the upper platform and coupled to the plurality of arms, and a lift joint between the upper platform and the lower platform and coupled to the proximal ends of the plurality of arms.

18. The umbrella assembly of claim 17 wherein the base assembly comprises a plurality of legs coupled between the upper platform and the lower platform.

19. A method for making an umbrella assembly comprising:
providing an umbrella;
coupling the umbrella into a stand for moving the umbrella on a surface, the stand comprising
a base assembly to receive the umbrella and being over the surface,
a plurality of arms, each arm having a proximal end coupled to the base assembly, and a distal end extending outwardly from the base assembly,
a plurality of wheels respectively coupled to the distal ends of the plurality of arms,
a plurality of supports coupled to the base assembly and extending outwardly from the base assembly, each of the plurality of supports comprises a pivot point for a respective one of the plurality of arms, and
an actuator assembly coupled to the base assembly and configured to cause the base assembly to switch between a first stationary state and a second movable state, the first stationary state comprising the distal ends of plurality of arms with the plurality of the wheels extending upward and away from the surface and the base assembly adjacent to the surface, the second moving state comprising the distal ends of plurality of arms with the plurality of the wheels abutting the surface and the base assembly being spaced apart from the surface.

20. The method of claim 19 wherein the base assembly comprises an upper platform to receive the umbrella, a lower platform coupled to the upper platform, a plurality of legs coupled between the upper platform and the lower platform, and a lift joint between the upper platform and the lower platform and coupled to the proximal ends of the plurality of arms.
